(19) United States
(12) Patent Application Publication
(10) Pub. No.: US 2011/0134262 A1
(43) Pub. Date: Jun. 9, 2011

(54) CAMERA MODULE, IMAGE RECORDING METHOD, AND ELECTRONIC DEVICE

(75) Inventor: Takayuki OGASAHARA, Kanagawa (JP)

(73) Assignee: KABUSHIKI KAISHA TOSHIBA, Tokyo (JP)

(21) Appl. No.: 12/881,514

(22) Filed: Sep. 14, 2010

(30) Foreign Application Priority Data
Dec. 7, 2009 (JP) 2009-277456

(51) Int. Cl. H04N 5/228; G03B 41/00; H04N 5/225

(52) U.S. Cl. 348/222.1; 396/332; 348/335; 348/E05.031; 348/E05.024

(57) ABSTRACT

According to one embodiment, a camera module includes two or more sub camera modules and a block matching unit. The two or more sub camera modules are fixed in an arrangement in which directions of optical axes of the imaging optical systems differ to each other. The block matching unit matches the images of the subject of the respective sub camera modules in portions where the image circles of the imaging optical systems overlap with each other.

### CROSS-REFERENCE TO RELATED APPLICATIONS

This application is based upon and claims the benefit of priority from the prior Japanese Patent Application No. 2009-277456, filed on Dec. 7, 2009; the entire contents of which are incorporated herein by reference.

### FIELD

Embodiments described herein relate generally to a camera module, an image recording method, and an electronic device.

### BACKGROUND

In some camera modules for imaging a subject, a distance between a lens and an imaging device (focal distance) is shortened as much as possible so as to make a camera module thinner. When the so called panoramic image having a wide field is obtained using the thin camera module, a method for synthesizing images photographed in such a manner that a part of imaging regions overlap with each other may be used. Conventionally, as a method for obtaining a panoramic image, there is known a method for photographing a plurality of times while moving one camera module, and then synthesizing the obtained images using a software, for example. However, since an amount of movement by which the camera module is moved easily varies significantly depending on the photographer or the timing of photographing, the quality of the synthetic image is unstabilized and further the images may not be synthesized. In addition, depending on the accuracy variations of a software used to synthesize image, it may be easy to visually recognize a seam between the synthesized images so as to significantly spoil the quality of the image. If a super wide-angle lens is used as an imaging optical system, it is difficult to make a camera module thin due to the thickness of the lens.

### BRIEF DESCRIPTION OF THE DRAWINGS

FIG. 1 is a perspective view illustrating a schematic structure of a camera module according to an embodiment;

FIG. 2 is a view for describing an arrangement of sub camera modules;

FIG. 3 is a view illustrating an example of image circles of respective sub camera modules;

FIG. 4 is an exploded view of a substrate;

FIG. 5 is a block diagram illustrating a structure for signal processing in a camera module;

FIG. 6 is a view for describing a relationship between a subject distance and overlapping of image circles;

FIGS. 7A to 7C are views for describing parallax of images of a subject;

FIGS. 8 and 9 are external views each illustrating a structure example of a mobile telephone mounted with a camera module; and

FIG. 10 is a view for describing a condition where no cross point exists.

### DETAILED DESCRIPTION

In general, according to one embodiment, a camera module includes two or more sub camera modules and a block matching unit. Each of the sub camera modules includes an imaging device and an imaging optical system for taking light into the imaging device. The sub camera module images a subject to obtain images of the subjects. The block matching unit performs a process of block matching for aligning the images of the subject. The two or more sub camera modules are fixed in an arrangement in which directions of optical axes of the imaging optical systems differ to each other. The block matching unit matches the images of the subject of the respective sub camera modules in portions where the image circles of the imaging optical systems overlap.

Exemplary embodiments of a camera module, an image recording method and an electronic device will be explained below in detail with reference to the accompanying drawings. The present invention is not limited to the following embodiments.

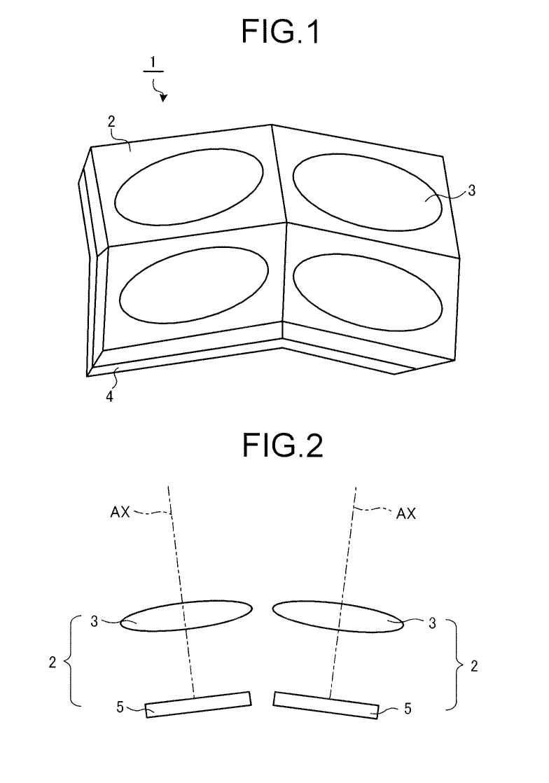

FIG. 1 is a perspective view illustrating a schematic structure of a camera module 1 according to the embodiment. The camera module 1 is structured by assembling four sub camera modules 2.

Each of the sub camera modules 2 is constituted by a wafer-level camera. The wafer-level camera is a camera module manufactured by appropriating the semiconductor manufacturing process. For the wafer-level camera, thousands of lenses are manufactured on one wafer at the same time. Then, optical elements are patched in a wafer level so that an optical part for a camera is manufactured. Therefore, with a wafer-level camera, a lens can be simply formed and parts can be simply assembled, whereby manufacturing const of optical parts can be significantly reduced.

The sub camera modules 2 are arranged in a matrix of 2×2 of rows and columns, for example. Each of the sub camera modules 2 includes an imaging device and an imaging lens 3. The imaging lens 3 functions as an imaging optical system for taking light from the subject and causing ₜhe light to enter into the imaging device. The imaging device converts the light taken by the imaging lens 3 into signal charges. Every imaging device of the respective sub camera modules 2 is structured to have pixels of RGB in Bayer Arrangement. The four sub camera modules are fixed on a substrate 4 in an arrangement in which directions of optical axes of the imaging lenses 3 differ to each other.

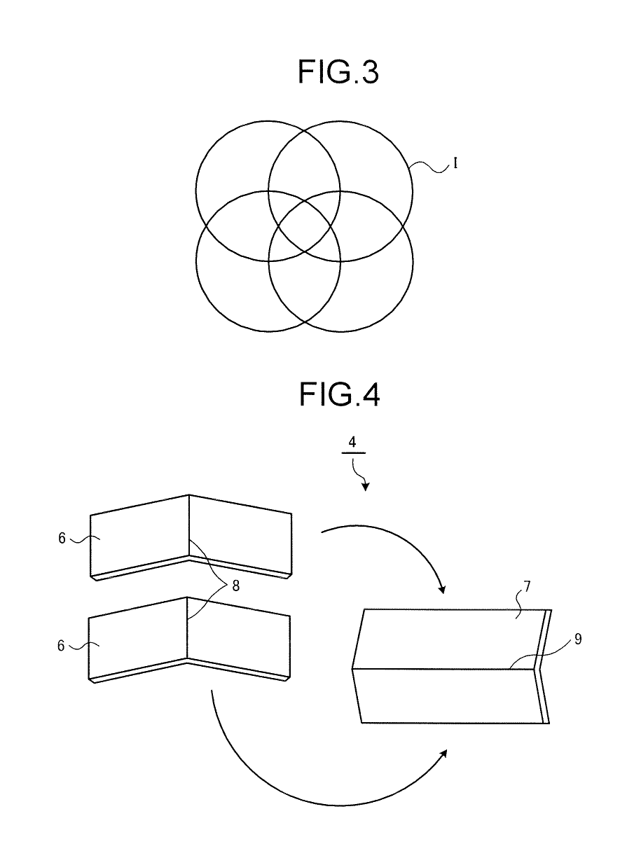

FIG. 2 is a view for describing an arrangement of the sub camera modules 2. In FIG. 2, two adjacent sub camera modules 2 are illustrated and a structure that is not necessary for the description is not illustrated. The imaging devices 5 are fixed perpendicularly to optical axes of the respective imaging lenses 3. Each of the sub camera modules 2 is arranged to tilt so that the space between the optical axes AX increases as a distance from the camera module 1 increases. By thus arranging each of the sub camera module 2 to tilt so that the sub camera module 2 face outward from each other, a synthetic image having a wide field can be obtained. Each of the sub camera modules 2 is structured in such a manner that a part of image circles I overlap each other as illustrated in FIG. 3. With this configuration, subject images that can be synthesized into one image can be obtained by respective sub camera modules 2.

FIG. 4 is an exploded view of a substrate 4. The substrate 4 includes two substrates for sub camera modules 6 and one substrate for set modules 7. On each of the substrates for sub camera modules 6, two sub camera modules 2 are mounted. Each of the substrates for sub camera modules 6 is bent at a bending position 8 at a predetermined angle. Two sub camera modules 2 are respectively fixed on the surface of each of the substrate for sub camera modules 6 across the bending position 8 where the substrate for sub camera modules 6 is mountain bent. Here, the structure in which two sub camera modules 2 are mounted on a substrate for sub camera modules 6 is called a set module.

The substrate for set modules 7 is bent at a bending position 9 at a predetermined angle. The bending position 9 of the substrate for set modules 7 is defined to be perpendicular to the bending position 8 of the set modules. The two set modules are respectively fixed on the surface of the substrate for set modules across the bending position 9 where the substrate for set modules 7 is mountain bent. By this configuration, to the substrate 4, the sub camera modules 2 are respectively fixed to tilt so that the optical axes make a predetermined angle with each other. The sub camera modules 2 are fixed to the substrates for sub camera modules 6 and the substrates for sub camera modules 6 are fixed to the substrate for set modules 7 by bonding, for example.

The camera module 1 may be formed by mounting four sub camera modules 2 on a substrate made of one member. In this case, in order to suppress variations of accuracy for mounting the sub camera modules 2, it is preferable to prepare a substrate in a four-sided pyramid shape and to mount the sub camera modules 2 on the surface thereof.

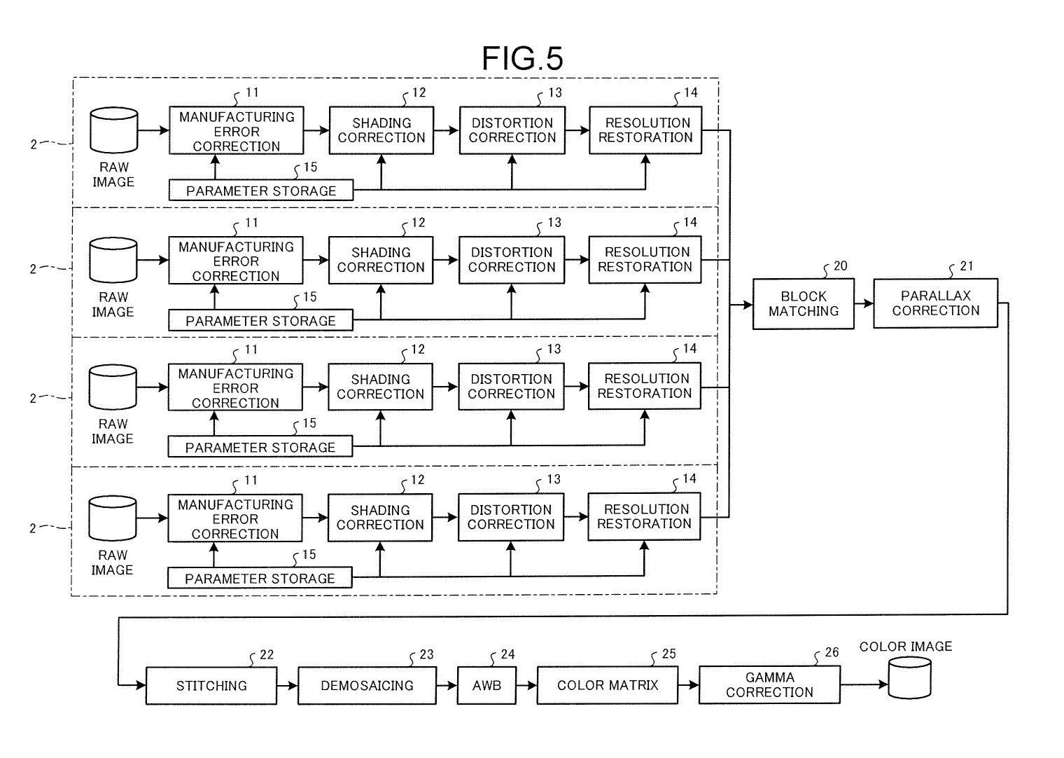

FIG. 5 is a block diagram illustrating a structure for signal processing in a camera module 1. The signal processing of the camera module 1 is roughly divided into processing of each of the sub camera modules 2 and processing of a processor of the camera module 1. Each of the sub camera modules 2 includes a manufacturing error correction unit 11, a shading correction unit 12, a distortion correction unit 13, a resolution restoring unit 14, and a parameter storing unit 15. The manufacturing error correction unit 11, the shading correction unit 12, the distortion correction unit 13, and the resolution restoring unit 14 perform signal processing on a RAW images obtained through photographing by the sub camera modules 2.

Parameters used for the signal processing are written to and held by the parameter storing unit 15. Individual information of the sub camera modules 2 may be stored as parameters so that signal processing corresponding to individual difference of the sub camera modules 2 is possible. The Individual information is information related to the individual difference of the respective sub camera modules 2 including manufacturing error of parts such as a lens, and assembling error of parts, for example. The Individual information also includes information related to mounting error of sub camera modules 2 on the camera module 1.

The manufacturing error correction unit 11 corrects a position misalignment of an image of the subject due to the manufacturing error of the camera module 1. The manufacturing error correction unit 11 corrects the position misalignment of the image of the subject based on position misalignment information previously stored in the parameter storing unit 15. In the position misalignment information, a parameter representing an amount of misalignment of the image of the subject due to the mounting error of each of the sub camera modules 2 in the XY plane (rotation) and in the Z axis (tilt), for example.

The shading correction unit 12 corrects luminance non-uniformity due to the imaging lens 3, especially a difference of quantities of light between the center portion and the peripheral portion of the image of the subject (shading correction). The shading correction unit 12 performs shading correction on the image of the subject referring to a parameter previously stored in the parameter storing unit 15. The distortion correction unit 13 corrects distortion of the image of the subject due to the imaging lens 3. The distortion correction unit 13 corrects distortion of the image of the subject referring to a parameter previously stored in the parameter storing unit 15.

The resolution restoring unit 14 estimates lens characteristics of the imaging lens 3 such as chromatic aberration of magnification and blur amount causing color blurring on the outline to perform the resolution restoring process. The resolution restoring unit 14 estimates lens characteristics of the imaging lens 3 referring to a parameter previously stored in the parameter storing unit 15. PSF (Point Spread Function) which is an optical transfer coefficient may be used as lens characteristics, for example. The resolution restoring unit 14 estimates PSF by method of least squares, for example. The effect of the resolution restoration depends on an algorithm used for the restoration. In the resolution restoring process, in order to restore an image close to an original image of the subject, Richardson-Lucy method may be used, for example.

The processor of the camera module 1 includes a block matching unit 20, a parallax correction unit 21, a stitching unit 22, a demosaicing unit 23, an auto white balance (AWB) processing unit 24, a color matrix processing unit 25, and a gamma correction unit 26.

The block matching unit 20 performs a process of block matching (pattern matching) on a RAW image of each of the sub camera modules 2 after the manufacturing error correction, the shading correction, the distortion correction and the resolution restoration. The block matching unit 20 aligns images of the subject obtained by the respective sub camera modules 2 through the process of block matching. The block matching unit 20 matches the images of the subject of the respective sub camera modules 2 in portions where the image circles I (refer to FIG. 3) overlap.

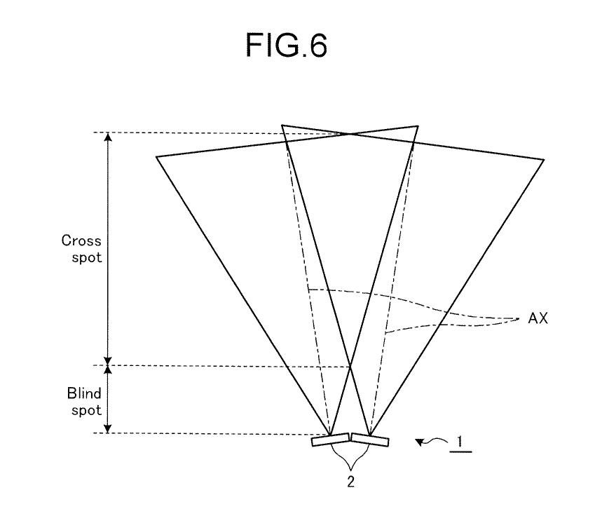

FIG. 6 is a view for describing a relationship between a distance from the camera module 1 to the subject (appropriately called “subject distance” hereinafter) and overlapping of image circles I. For example, in the case of near distance, image circles I do not overlap so as to generate a spot where the subject can be imaged by a sub camera module 2 but cannot be imaged by another sub camera module 2 (blind spot). In the case where the subject distance is equal to or more than a predetermined distance, image circles I overlap so as to generate a spot where the subject can be imaged by any of the sub camera modules 2 (cross spot). As the subject distance increases, the size of a portion where the image circles I overlap with each other increases.

The block matching unit 20 detects a portion where the image circles I overlap with each other depending on the subject distance and performs the process of block matching for matching the images of the subject in the overlapping portion. The parallax correction unit 21 calculates an amount of parallax in the images of the subject obtained by the respective sub camera modules 2 to correct parallax depending on the amount of parallax.

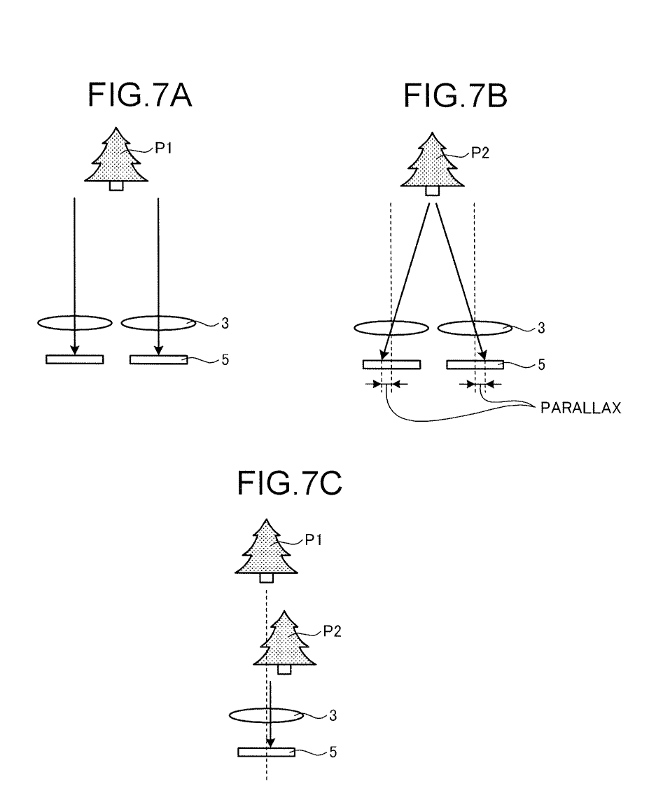

FIGS. 7A to 7C are views for describing parallax of images of a subject. FIG. 7A illustrates a case where a subject P1 is in the infinity. In this case, parallax does not occur in the images of the subject obtained by respective sub camera modules 2. FIG. 7B illustrates a case where a subject P2 is at a close distance. Parallax is a phenomenon that image location differs at a close distance. When parallax occurs, if color images are synthesized without considering the parallax, the resultant image may be blurred to significantly spoil the quality of the image. In the case of using the camera module 1 including four sub camera modules 2 arranged in a matrix, the images of the subject obtained by the respective sub camera modules 2 are affected by parallax.

A plurality of sub camera modules 2 may be arranged around a sub camera module 2 by modifying the embodiment. In this case, regarding to the center sub camera module 2, parallax does not occur in an image of the subject either for the subject P1 in the infinity or the subject P2 at the close distance as illustrated in FIG. 7C. Regarding to sub camera modules 2 other than the center sub camera module 2, parallax occurs in images of the subject.

If the images of a subject having parallax were synthesized, the quality of the image could be degraded due to the unnatural seam between the images. After the process by the parallax correction unit 21, the seam between the images in the overlapping portions of the image circles I is made less noticeable so that a natural image can be obtained. The parallax correction unit 21 estimates an amount of parallax by triangulation method or the like based on position information of the image of the subject corrected by the manufacturing error correction unit 11.

The stitching unit 22 performs a stitching process on each of the images of the subject for synthesizing. For a portion where the image circles I overlap, the stitching unit 22 keeps an image of the subject of one sub camera module 2 and removes images of the subject of other sub camera modules 2. At this time, an interpolation process is performed on a seam part between the images of the subject, whereby a natural image having a seam made less noticeable can be obtained.

The demosaicing unit 23 obtains a color synthetic image by performing a demosaicing process on the image obtained by synthesizing by the stitching unit 22. The AWB processing unit 24 performs an AWB process. The AWB process is a process for correcting an image to accurately show white color as white by adjusting a gain value of RGB corresponding to the spectral distribution of color temperature.

The color matrix processing unit 25 performs color matrix calculation (color reproduction process) for achieving color reproducibility. The gamma correction unit 26 performs gamma correction for correcting chroma and brightness of an image. The camera module 1 outputs the color image obtained by thus synthesizing.

The steps of processes described in the embodiment is merely an example and another process may be added or the order of the processes may be changed appropriately. The demosaicing process by the demosaicing unit 23 may be performed before synthesizing by the stitching unit 22, for example. In addition, signal processing by respective elements may be performed either of the respective sub camera modules 2 or the processor of the camera module 1, alternatively, may be shared by both of them.

Since respective sub camera modules 2 are fixed with a previously given predetermined tilt, the camera module 1 of the embodiment can obtain a synthetic image having a wide field more stably comparing to a case where photographing is performed a plurality of times while moving one camera module. By fixing the respective sub camera modules 2, the manufacturing error of the camera module 1, especially the position misalignment of the images of the subject due to the mounting error of the sub camera modules 2 can be corrected. Accordingly, in the process of block matching, the images of the subject can be synthesized with a high accuracy. In addition, according to the embodiment, super wide-angle lens is not necessary so that it is possible to make the camera module 1 thin.

The number of the sub camera modules 2 provided in the camera module 1 is not limited to four and may be any number of two or more. In addition, the arrangement of the sub camera modules 2 in a matrix having some rows and columns may be appropriately changed to an arrangement where the sub camera modules 2 are parallely arranged in line, for example.

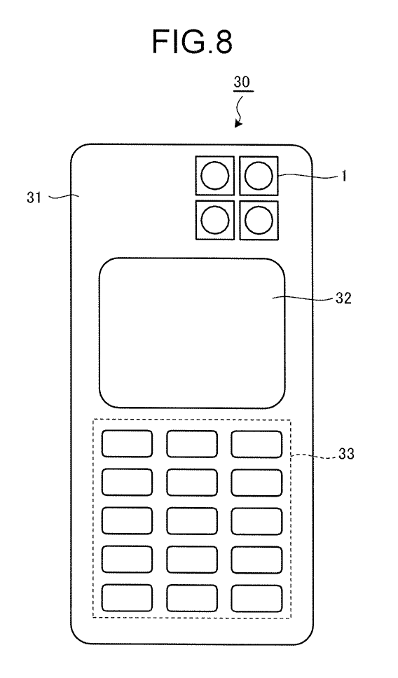

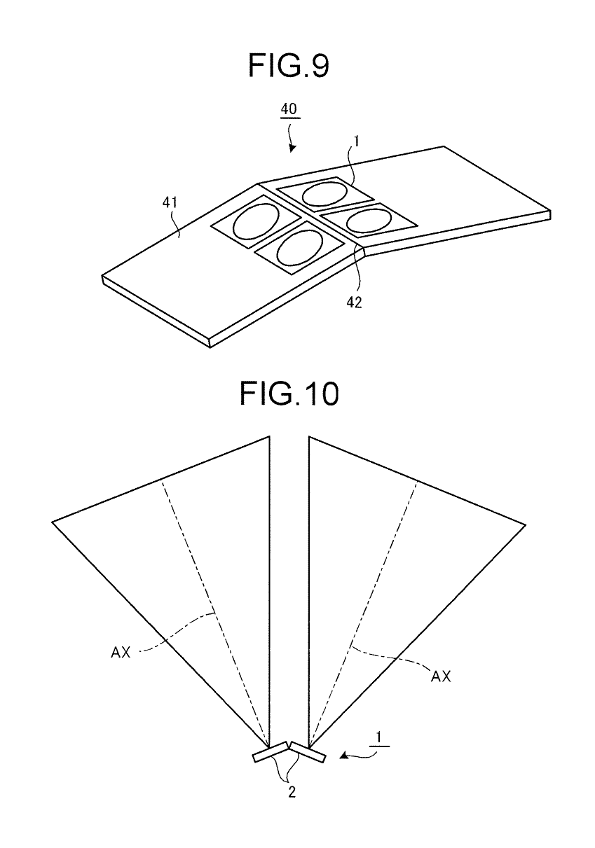

Next, an example of the application of the camera module 1 to an electronic device will be described. FIGS. 8 and 9 are external views each illustrating a structure example of a mobile telephone mounted with the camera module 1. In a mobile telephone 30 illustrated in FIG. 8, the camera module 1 is provided on a surface of a housing 31 on the side where a display unit 32 and an operation unit 33 are provided. The mobile telephone 30 mounted with the camera module 1 can stably obtain a synthetic image having a wide field. The camera module 1 may be provided any position on the housing 31.

A mobile telephone 40 illustrated in FIG. 9 adopts flip type allowing the mobile telephone 40 to be opened to an open state and closed to a flipped state. The camera module 1 is provided on a surface, which faces outside when the mobile telephone 40 is flipped, of a housing 41 of the mobile telephone 40. The mobile telephone 40 of flip type may be configured to allow the flipped angle at a hinge portion 42 to be changed so that the field angle that can be photographed by the camera module 1 can be changed.

The camera module 1 recognizes the flipped angle by a sensor (not shown) mounted on the hinge portion 42, for example. The camera module 1 sets a parameter for signal processing in such a manner that the degree of overlapping of the image circles is changed corresponding to the flipped angle, for example. An area of a cross point where the image circles overlap becomes larger as the flipped angle is smaller (closer to a state where the mobile telephone is completely flipped). On the other hand, an area of a cross point becomes smaller as the flipped angle is larger so that the field angle that can be photographed becomes larger.

However, when the flipped angle becomes larger than a predetermined angle, no cross point exists as illustrated in FIG. 10, and the images of the subject of the sub camera module 2 cannot be synthesized. The mobile telephone 40 may have a function for preventing a failure of the panoramic image by alarming or by canceling the process of synthesizing the images of the subject when the flipped angle becomes larger than the predetermined angle, for example.

In addition, the camera module may previously hold a parameter at a flipped angle and may perform signal processing for panorama photographing by opening the mobile telephone 40 at the flipped angle. In this case, the mobile telephone 40 may be structured to once stop at the flipped angle for a panorama photographing mode in an open/close operation.

An electronic device to which the camera module 1 can be applied is not limited to a mobile telephone. The camera module 1 may be applied to any electronic device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera module comprising:
two or more sub camera modules each of which includes an imaging device and an imaging optical system for taking light into the imaging device, and which images a subject to obtain images of the subjects; and
a block matching unit that performs a process of block matching for aligning the images of the subject, wherein
the two or more sub camera modules are fixed in an arrangement in which directions of optical axes of the imaging optical systems differ to each other, and
the block matching unit matches the images of the subject of the respective sub camera modules in a portion where image circles of the imaging optical systems overlap with each other.

2. The camera module according to claim 1, wherein the block matching unit detects a portion where the image circles overlap with each other depending on a subject distance.

3. The camera module according to claim 1, wherein each of the sub camera modules includes a manufacturing error correction unit that corrects a position misalignment of the images of the subject due to the manufacturing error of the camera module.

4. The camera module according to claim 3, wherein the manufacturing error correction unit corrects the position misalignment based on position misalignment information stored for each of the sub camera modules.

5. The camera module according to claim 4, further comprising a parameter storing unit that holds a parameter including the position misalignment information.

6. The camera module according to claim 1, further comprising a parallax correction unit that corrects parallax of the images of the subject.

7. The camera module according to claim 6, wherein each of the sub camera modules includes a manufacturing error correction unit that corrects a position misalignment of the images of the subject due to a manufacturing error of the camera module, and
the parallax correction unit estimates an amount of parallax based on position information of the image of the subject corrected by the manufacturing error correction unit.

8. The camera module according to claim 1 further comprising a stitching unit that performs a stitching process for synthesizing the images of the subject, wherein
the stitching unit keeps one of the images of the subject of one of the sub camera modules and removes other of the images of the subject of other of the sub camera modules for a portion where the image circles overlap.

9. The camera module according to claim 1, wherein the two or more sub camera modules are mounted on a substrate having a bending position where the substrate is bent at a predetermined angle.

10. The camera module according to claim 1, wherein the two or more sub camera modules are arranged to tilt so that the space between the optical axes increases when a distance from the camera module increases.

11. An image recording method comprising:
imaging a subject to obtain images of the subject by two or more sub camera modules each of which includes an imaging device and an imaging optical system for taking light into the imaging device, and which are arranged in such a manner that an optical axis of the imaging optical system differs to another optical axis or other optical axes;
performing a process of block matching for aligning the images of the subject; and
matching the images of the subject of the respective sub camera modules in a portion where image circles of the imaging optical systems overlap with each other.

12. The image recording method according to claim 11, wherein the portion where the image circles overlap with each other is detected depending on a subject distance.

13. The image recording method according to claim 11, further comprising correcting a position misalignment of the images of the subject due to a manufacturing error of the camera module including the two or more sub camera modules.

14. The image recording method according to claim 13, wherein the position misalignment is corrected based on position misalignment information stored for each of the sub camera modules.

15. The image recording method according to claim 14, wherein the position misalignment information includes a parameter representing an amount of misalignment of each of the images of the subject due to a mounting error of each of the sub camera modules.

16. The image recording method according to claim 11, further comprising correcting parallax of the images of the subject.

17. The image recording method according to claim 16 further comprising:
correcting a position misalignment of the images of the subject due to a manufacturing error of the camera module including the two or more sub camera modules; and estimating an amount of parallax based on position information of the corrected images of the subject.

18. The image recording method according to claim 11 further comprising performing a stitching process for synthesizing the images of the subject, wherein
in the stitching process, for a portion where the image circles overlap, one of the images of the subject of one of the sub camera modules is kept and other of the images of the subject of other of the sub camera modules is removed.

19. An electronic device comprising a camera module including:
two or more sub camera modules each of which includes an imaging device and an imaging optical system for taking light into the imaging device, and which images a subject to obtain images of the subjects; and
a block matching unit that performs a process of block matching for aligning the images of the subject, wherein
the two or more sub camera modules are fixed in an arrangement in which directions of optical axes of the imaging optical systems differ to each other, and
the block matching unit matches the images of the subject of the respective sub camera modules in a portion where image circles of the imaging optical systems overlap with each other.

20. The electronic device according to claim 19, wherein each of the sub camera modules further includes a manufacturing error correction unit that corrects a position misalignment of the images of the subject due to a manufacturing error of the camera module.
